(19) United States
(12) Patent Application Publication
(10) Pub. No.: US 2016/0245983 A1
(43) Pub. Date: Aug. 25, 2016

(54) LIQUID CRYSTAL DISPLAY DEVICE

(71) Applicant: SHENZHEN CHINA STAR OPTOELECTRONICS TECHNOLOGY CO., LTD., Shenzhen, Guangdong (CN)

(72) Inventors: Shuichih LIEN, Shenzhen (CN); Chihtsung KANG, Shenzhen (CN); Yicheng KUO, Shenzhen (CN)

(73) Assignee: Shenzhen China Star Optoelectronics Technology Co., Ltd., Shenzhen, Guangdong (CN)

(21) Appl. No.: 14/428,353

(22) PCT Filed: Oct. 28, 2014
(86) PCT No.: PCT/CN2014/089617

§ 371 Date: Mar. 14, 2015

(30) Foreign Application Priority Data
Sep. 30, 2014 (CN) 201410524674.1

(51) Int. Cl. F21V 8/00; G02F 1/1335

(52) U.S. Cl. CPC G02B 6/0053; G02F 1/133514; G02F 1/133528; G02F 1/133504; G02B 6/0056; G02B 6/0055; G02B 6/0038

(57) ABSTRACT

The present invention provides a liquid crystal display device, which includes a liquid crystal panel (1) and a collimated exit light backlight module (3). The liquid crystal panel (1) includes a CF substrate (11), an array substrate (13), and a liquid crystal layer (12). The CF substrate (11) has an upper surface on which an upper polarizer film (15) is arranged. The array substrate (13) has a lower surface on which a lower polarizer film (17) is arranged. The collimated exit light backlight module (3) includes a light guide plate (31), at least one backlight source (33), an optic film assembly (35), and a bottom reflector plate (37). The upper polarizer film (15) includes a view angle diffusion film (19) arranged thereon. The optic film assembly (35) includes a birefringent polarizer (351). The birefringent polarizer (351) separates polarized lights. The liquid crystal display device greatly improves light transmittance and light extraction efficiency and also effectively overcomes the issue of color deviation at a large view angle.

### BACKGROUND OF THE INVENTION

1. Field of the Invention

The present invention relates to the field of liquid crystal display technology, and in particular to a liquid crystal display device.

2. The Related Arts

Liquid crystal displays (LCDs) have a variety of advantages, such as thin device body, low power consumption, and being free of radiation, and are thus of wide applications, such as liquid crystal televisions, mobile phones, personal digital assistants (PDAs), digital cameras, computer monitors, and notebook computer screens.

Most of the currently available liquid crystal displays are backlighting liquid crystal displays, which comprise an enclosure, a liquid crystal panel arranged in the enclosure, and a backlight module mounted in the enclosure. The liquid crystal panel itself does not emit light and light must be supplied from the backlight module to the liquid crystal panel in order to normally display images

FIG. 1 shows a schematic view of a conventional liquid crystal display device. The structure of a conventional liquid crystal panel 100 is made up of a color filter (CF) substrate 110, a thin-film transistor (TFT) array substrate 130, and a liquid crystal layer filled between the two substrates and the principle of operation is that a driving voltage is applied to the CF substrate 110 and the array substrate 130 to control rotation of the liquid crystal molecules of the liquid crystal layer in order to control the amount of output light for refracting out light emitting from a backlight module 300 to generate images. The CF substrate 100 has an upper surface on which an upper polarizer film 150 is attached and the CF substrate 100 has a lower surface on which color resist is arranged by taking pixels as units. The array substrate 130 has a lower surface on which a lower polarizer film 170 that is normal to the upper polarizer film 150 in directions of axes thereof. The array substrate 130 has an upper surface on which TFT switches are provided for charging/discharging of the pixels. Formed atop the TFT switches is an indium tin oxide (ITO) electrode that controls the liquid crystal layer. The ITO electrode is arranged in a pattern that can be designed as an electrode pattern that is fit for a twisted nematic (TN) mode, or as a pattern that is fit for one-domain, two-domain, four-domain, or eight-domain vertical alignment (VA) mode, or a pattern that is fit for one-domain, two-domain, or four-domain in-plane switching (IPS) mode.

A conventional backlight module 300 comprises a backlight source 310, a light guide plate 330, a bottom reflector plate 350, and an optic film assembly 370. The backlight source 310 can be a light-emitting diode (LED), a cold cathode fluorescent lamp (CCFL), or a hot cathode fluorescent lamp (HCFL). The optic film assembly 370 comprises a diffuser film, a bright enhancement film, and a protection film.

The conventional liquid crystal television produces often adopt a driving method of a VA mode solution or an IPS mode solution in order to expand the view angle of displaying. The VA mode has advantages of high yield rate and high throughput; however, to reduce color shift for displaying at large view angles, the ITO electrode must adopt the eight-domain solution to improve color deviation at large view angles. Using ITO electrode of the eight-domain pattern would lead to a reduction of the yield rate of a manufacturing process, a reduction of the aperture ratio, a reduction of liquid crystal performance, and a reduction of light transmittance, and thus the cost of the backlight module is indirectly increased. On the other hand, using a two-domain or one-domain VA mode solution allows for a signification increase of light transmittance, but color deviation becomes apparently severe at large view angles.

Further, since a display panel of a liquid crystal television needs a large view angle for watching and view angel brightness must satisfy the view angle specification of ½ brightness or ⅓ brightness. The optic film assembly of the backlight module needs to have a relatively large light-exit view angle. Since the light transmittance of the liquid crystal panel at a large view angle is reduced, the light extraction performance of the backlight module gets deteriorated and the large view angle color deviation issue of the liquid crystal panel is made apparently identifiable.

### SUMMARY OF THE INVENTION

An object of the present invention is to provide a liquid crystal display device, which greatly improves light transmittance and light extraction efficiency and also effectively overcomes the issue of color deviation at a large view angle.

To achieve the above object, the present invention provides a liquid crystal display device, which comprises: a liquid crystal panel and a collimated exit light backlight module that provides a light source to the liquid crystal panel. The liquid crystal panel comprises a color filter (CF) substrate, an array substrate that is arranged opposite to the CF substrate, and a liquid crystal layer that is filled between the CF substrate and the array substrate. The CF substrate has a surface that is distant from the liquid crystal layer and comprises an upper polarizer film arranged thereon. The array substrate has a lower surface that is distant from the liquid crystal layer and comprises a lower polarizer film arranged thereon. The collimated exit light backlight module comprises a light guide plate, at least one backlight source arranged at one side of the light guide plate, an optic film assembly arranged above the light guide plate, and a bottom reflector plate arranged below the light guide plate. The upper polarizer film comprises a view angle diffusion film arranged thereon. The optic film assembly comprises a birefringent polarizer. The birefringent polarizer separates polarized lights.

The view angle diffusion film is a diffusive optic film made up of diffusion particles.

The view angle diffusion film adopts a prism-structure design. The view angle diffusion film has a lower surface on which a plurality of V-shaped projections is formed.

The view angle diffusion film comprises a plurality of diffractive optic units. The diffractive optic units are rectangular projections formed on the view angle diffusion film. A spacing distance between two adjacent ones of the diffractive optic units is equal to or less than a wavelength of a visible light.

The birefringent polarizer is made up of a microstructure anisotropic polymer layer.

The optic film assembly further comprises a microstructure brightness enhancement film. The microstructure brightness enhancement film generates a collimated exit light.

The microstructure brightness enhancement film adopts a prism-structured design.

The light guide plate has a lower surface comprising a plurality of inverted V-shaped troughs formed therein.

The optic film assembly further comprises an inverted prism-structured film. The inverted prism-structured film has a lower surface in which a plurality of inverted V-shaped troughs is formed.

The liquid crystal panel is a one-domain or two-domain vertical alignment (VA) mode liquid crystal panel.

The efficacy of the present invention is that the present invention provides a liquid crystal display device, which comprises an arrangement of a view angle diffusion film to give a component of a normal-view-angle exit light to a large-view-angel exit light so as to greatly increase light transmittance and thus overcome the issue of color deviation at a large view angle and an arrangement of a birefringent polarizer to separate polarized lights so as to provide a polarized exit light and thus greatly improve utilization rate of the light entering the liquid crystal panel, whereby the liquid crystal display device can greatly improve light transmittance and light extraction efficiency and may also effectively overcome the issue of color deviation at a large view angle.

For better understanding of the features and technical contents of the present invention, reference will be made to the following detailed description of the present invention and the attached drawings. However, the drawings are provided for the purposes of reference and illustration and are not intended to impose limitations to the present invention.

### BRIEF DESCRIPTION OF THE DRAWINGS

The technical solution, as well as other beneficial advantages, of the present invention will be apparent from the following detailed description of embodiments of the present invention, with reference to the attached drawing. In the drawing:

FIG. 1 is a schematic view showing the structure of a conventional liquid crystal display device;

FIG. 2 is a schematic view showing the structure of a liquid crystal display device according to the present invention;

FIG. 3 is a schematic view showing an embodiment of a view angle diffusion film included in the liquid crystal display device according to the present invention; and

FIG. 4 is a schematic view showing another embodiment of a view angle diffusion film included in the liquid crystal display device according to the present invention.

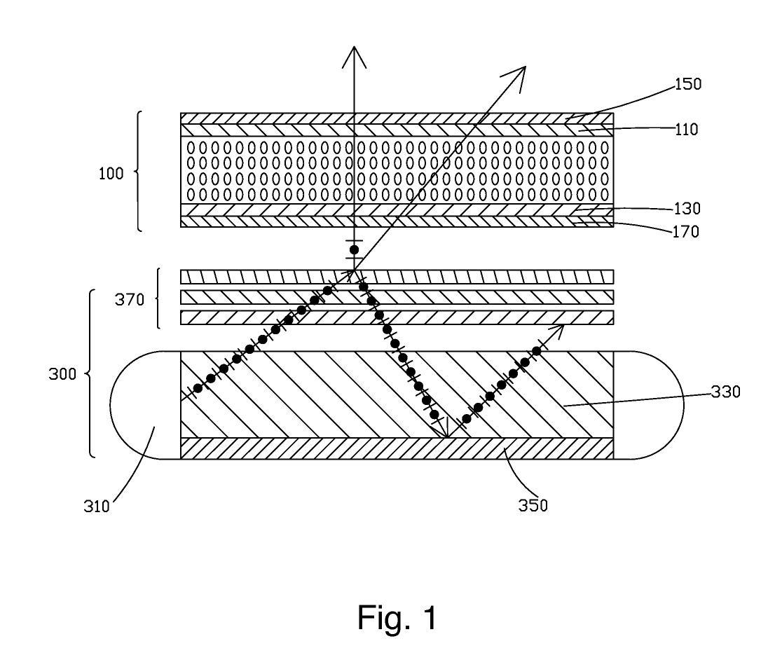

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

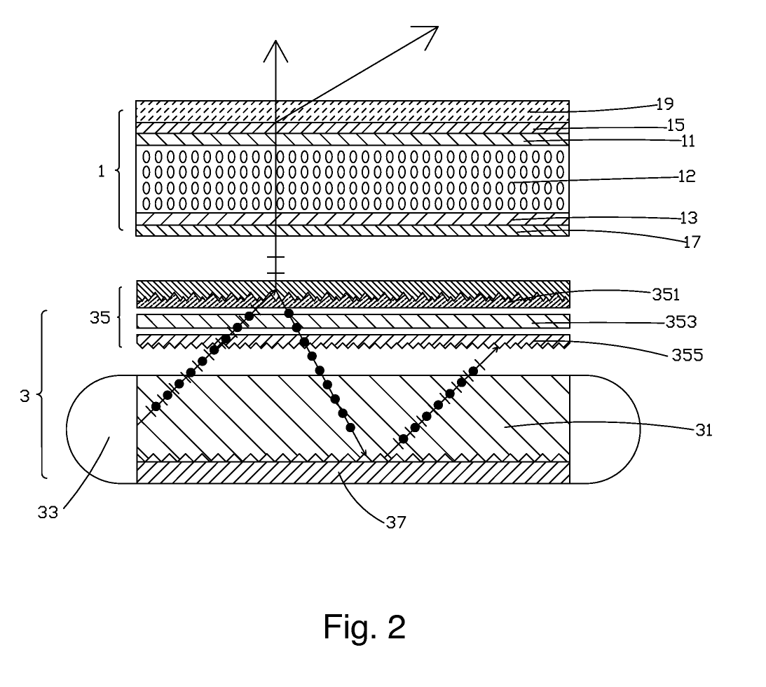

Referring to FIG. 2, the present invention provides a liquid crystal display device, which comprises a liquid crystal panel 1 and a collimated exit light backlight module 3 that provides a light source to the liquid crystal panel 1.

The liquid crystal panel 1 comprises a color filter (CF) substrate 11, an array substrate 13 that is arranged opposite to the CF substrate 11, and a liquid crystal layer 12 that is filled between the CF substrate 11 and the array substrate 13. The CF substrate 11 has an upper surface that is distant away from the liquid crystal layer 12 in a relative sense and comprises an upper polarizer film 15 attached thereto and a lower surface that is close to the liquid crystal layer 12 in a relative sense and comprises color resist arranged thereon by taking pixels as units. The array substrate 13 has a lower surface that is away from the liquid crystal layer 12 in a relative sense and comprises an upper polarizer film 15 that is normal to the lower polarizer film 17 in directions of axes thereof attached thereto and an upper surface that is close to the liquid crystal layer 12 in a relative sense and is provided with thin-film transistor (TFT) switches for charging/discharging the pixels. Formed atop the TFT switches is an indium tin oxide (ITO) electrode that controls the liquid crystal layer 12. The ITO electrode comprises a pattern design that can be a pattern fit for one-domain or two-domain vertical alignment (VA) mode liquid crystal panel. The one-domain or two-domain VA mode liquid crystal panel employs UV2A, PVA, or PSVA driving techniques, having an increased aperture ratio, enhanced liquid crystal performance, and a heightened light transmittance.

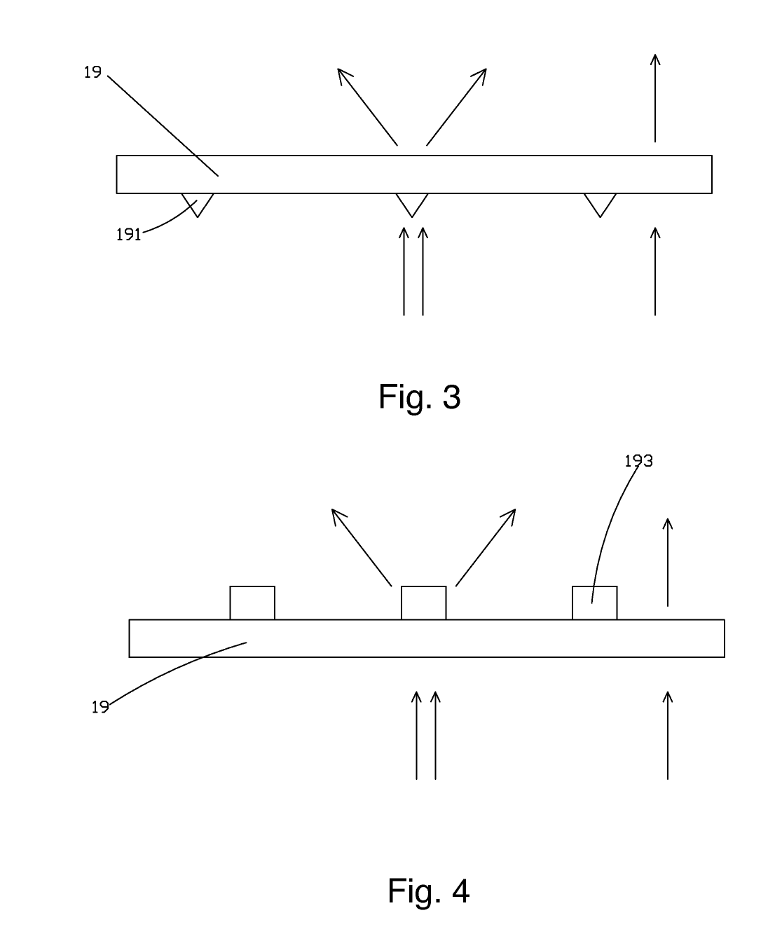

It is noted here that the upper polarizer film 15 comprises a view angle diffusion film 19 arranged thereon. More specifically, the view angle diffusion film 19 is adhesively bonded on the upper polarizer film 15. The view angle diffusion film 19 can be a diffusive optic film composed of diffusion particles; or alternatively, as shown in FIG. 3, the view angle diffusion film 19 may use a prism-structured design having a lower surface comprising a plurality of V-shaped projections 191 formed thereon; or further alternatively, as shown in FIG. 4, the view angle diffusion film 19 may comprise a plurality of diffractive optic units 193, where the diffractive optic units 193 comprise rectangular projections formed on an upper surface of the view angle diffusion film 19 and a spacing distance between two adjacent ones of the diffractive optic units 193 is equal to or less than the wavelength of a visible light. The view angle diffusion film 19 functions to give a component of a normal-view-angle exist light to a large-view-angle exit light, meaning a component of an exit light that is normal to the liquid crystal panel 1 is given to an inclined exit light, so as to greatly reduce color deviation caused by the large-view-angle exit light directly transmitting through the liquid crystal panel 1 thereby overcoming the problem of color deviation at a large view angle and thus greatly improving light transmittance.

The collimated exit light backlight module 3 comprises a light guide plate 31, at least one backlight source 33 arranged at one side of the light guide plate 31, an optic film assembly 35 arranged above the light guide plate 31, and a bottom reflector plate 37 arranged below the light guide plate 31.

Specifically, each of two opposite sides of the light guide plate 31 is provided with a backlight source 33 and the backlight sources 33 each comprise a light-emitting diode (LED) light source. The light guide plate 31 is provided, in a lower surface thereof, with a plurality of inverted V-shaped troughs by a V-cut process. The optic film assembly 35 has a surface that is close to the light guide plate 31 in a relative sense and comprises an inverted prism-structured film 355 thereon. The inverted prism-structured film 355 has a lower surface in which a plurality of inverted V-shaped troughs is formed. The light guide plate 31 and the inverted prism-structured film 355 in combination readily concentrate exit light distribution in a small view angel range for light exiting.

It is noted that the optic film assembly 35 may further comprises a microstructure brightness enhancement film 353, which may adopt a prism-structured design or other forms of structure. The microstructure brightness enhancement film 353 functions to generate a collimated exit light.

It is noted that the side of the optic film assembly 35 has a surface that is distant from the light guide plate 31 in a relative sense and comprises a birefringent polarizer 351 arranged thereon. Specifically, the birefringent polarizer 351 is made up of a microstructure anisotropic polymer layer. The birefringent polarizer 351 functions for S/P separation of polarized lights so as to provide a polarized exit light to thereby greatly improve utilization rate of the light entering the liquid crystal panel 1.

In summary, the present invention provides a liquid crystal display device, which comprises an arrangement of a view angle diffusion film to give a component of a normal-view-angle exit light to a large-view-angel exit light so as to greatly increase light transmittance and thus overcome the issue of color deviation at a large view angle and an arrangement of a birefringent polarizer to separate polarized lights so as to provide a polarized exit light and thus greatly improve utilization rate of the light entering the liquid crystal panel, whereby the liquid crystal display device can greatly improve light transmittance and light extraction efficiency and may also effectively overcome the issue of color deviation at a large view angle.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A liquid crystal display device, comprising: a liquid crystal panel and a collimated exit light backlight module that provides a light source to the liquid crystal panel, the liquid crystal panel comprising a color filter (CF) substrate, an array substrate that is arranged opposite to the CF substrate, and a liquid crystal layer that is filled between the CF substrate and the array substrate, the CF substrate having a surface that is distant from the liquid crystal layer and comprises an upper polarizer film arranged thereon, the array substrate having a lower surface that is distant from the liquid crystal layer and comprises a lower polarizer film arranged thereon, the collimated exit light backlight module comprising a light guide plate, at least one backlight source arranged at one side of the light guide plate, an optic film assembly arranged above the light guide plate, and a bottom reflector plate arranged below the light guide plate, the upper polarizer film comprising a view angle diffusion film arranged thereon, the optic film assembly comprising a birefringent polarizer, the birefringent polarizer separating polarized lights.

2. The liquid crystal display device as claimed in claim 1, wherein the view angle diffusion film is a diffusive optic film made up of diffusion particles.

3. The liquid crystal display device as claimed in claim 1, wherein the view angle diffusion film adopts a prism-structure design, the view angle diffusion film having a lower surface on which a plurality of V-shaped projections is formed.

4. The liquid crystal display device as claimed in claim 1, wherein the view angle diffusion film comprises a plurality of diffractive optic units, the diffractive optic units being rectangular projections formed on the view angle diffusion film, a spacing distance between two adjacent ones of the diffractive optic units being equal to or less than a wavelength of a visible light.

5. The liquid crystal display device as claimed in claim 1, wherein the birefringent polarizer is made up of a microstructure anisotropic polymer layer.

6. The liquid crystal display device as claimed in claim 1, wherein the optic film assembly further comprises a microstructure brightness enhancement film, the microstructure brightness enhancement film generating a collimated exit light.

7. The liquid crystal display device as claimed in claim 6, wherein the microstructure brightness enhancement film adopts a prism-structured design.

8. The liquid crystal display device as claimed in claim 1, wherein the light guide plate has a lower surface comprising a plurality of inverted V-shaped troughs formed therein.

9. The liquid crystal display device as claimed in claim 1, wherein the optic film assembly further comprises an inverted prism-structured film, the inverted prism-structured film having a lower surface in which a plurality of inverted V-shaped troughs is formed.

10. The liquid crystal display device as claimed in claim 1, wherein the liquid crystal panel is a one-domain or two-domain vertical alignment (VA) mode liquid crystal panel.

11. A liquid crystal display device, comprising: a liquid crystal panel and a collimated exit light backlight module that provides a light source to the liquid crystal panel, the liquid crystal panel comprising a color filter (CF) substrate, an array substrate that is arranged opposite to the CF substrate, and a liquid crystal layer that is filled between the CF substrate and the array substrate, the CF substrate having a surface that is distant from the liquid crystal layer and comprises an upper polarizer film arranged thereon, the array substrate having a lower surface that is distant from the liquid crystal layer and comprises a lower polarizer film arranged thereon, the collimated exit light backlight module comprising a light guide plate, at least one backlight source arranged at one side of the light guide plate, an optic film assembly arranged above the light guide plate, and a bottom reflector plate arranged below the light guide plate, the upper polarizer film comprising a view angle diffusion film arranged thereon, the optic film assembly comprising a birefringent polarizer, the birefringent polarizer separating polarized lights;
wherein the view angle diffusion film is a diffusive optic film made up of diffusion particles;
wherein the birefringent polarizer is made up of a microstructure anisotropic polymer layer;
wherein the optic film assembly further comprises a microstructure brightness enhancement film, the microstructure brightness enhancement film generating a collimated exit light;
wherein the microstructure brightness enhancement film adopts a prism-structured design;
wherein the light guide plate has a lower surface comprising a plurality of inverted V-shaped troughs formed therein;
wherein the optic film assembly further comprises an inverted prism-structured film, the inverted prism-structured film having a lower surface in which a plurality of inverted V-shaped troughs is formed; and
wherein the liquid crystal panel is a one-domain or two-domain vertical alignment (VA) mode liquid crystal panel.
